(19) United States
(12) Patent Application Publication
(10) Pub. No.: US 2021/0094582 A1
(43) Pub. Date: Apr. 1, 2021

(54) AFTER-MARKET VEHICLE COPILOT DEVICE

(71) Applicant: Bluebox Labs, Inc., Seattle, WA (US)

(72) Inventors: Minsoo LEE, Seattle, WA (US); Levi BISONN, Seattle, WA (US); Youngchan CHO, Seattle, WA (US)

(21) Appl. No.: 17/028,751

(22) Filed: Sep. 22, 2020

Related U.S. Application Data
(60) Provisional application No. 62/907,533, filed on Sep. 27, 2019.

(51) Int. Cl. B60W 60/00; B60W 40/12; G01C 22/00; B60W 40/08; G11B 27/036

(52) U.S. Cl. CPC B60W 60/0051; B60W 40/12; G01C 22/00; B60W 40/08; H04N 7/183; B60W 2420/42; B60W 2530/00; B60W 2420/40; B60W 2520/00; G11B 27/036

(57) ABSTRACT

Described herein is a system that includes a copilot device that can be installed as “aftermarket” within a vehicle in order to enable various functionality that would not typically be available for the vehicle. In some embodiments, the copilot device includes a number of cameras and sensors that collect information related to a vehicle in which the copilot device is installed. The copilot device is also communicatively coupled to the vehicle itself and receives data directly from the vehicle. The copilot device is capable of generating a data file that includes a number of data types that are synchronized based on time.

### BACKGROUND

Dashcam systems typically record video with little or no other functionality. Dashcam systems are typically challenging to install. Once installed, dashcam systems typically lack portability. Information collected by dashcams is typically limited to video footage, sometimes with sound, that can be used for entertainment purposes or as evidence in a civil or criminal investigation.

Camera systems for autonomous vehicles are not typically available for after-market installation in pre-existing vehicles. Autonomous vehicle camera systems provide little or no information that is useful to the owner of the vehicle beyond that of dashcam systems.

### SUMMARY

Techniques are provided herein for enabling automation of various functions associated with a vehicle via the use of a copilot device installed within the vehicle. Various embodiments are described herein, including methods, systems, non-transitory computer-readable storage media storing programs, code, or instructions executable by one or more processors, and the like.

In one embodiment, a method is disclosed as being performed by a copilot device, the method comprising receiving video data obtained by a camera included in the copilot device, receiving vehicle data via a connection between a vehicle and the copilot device, receiving sensor data from one or more sensors in communication with the copilot device, generating a modified video file that includes the video data, at least a portion of the vehicle data, and at least a portion of the sensor data, and transmitting the modified video file to a copilot management computer remote to the copilot device.

An embodiment is directed to a copilot computing device comprising one or more cameras; a connection between a vehicle and the copilot computing device; one or more sensors; a processor; and a memory including instructions that, when executed with the processor, cause the copilot computing device to, at least: receive video data obtained by the one or more cameras included in the copilot device, receive vehicle data via the connection between a vehicle and the copilot computing device, receive sensor data from the one or more sensors in communication with the copilot device, generate a modified video file that includes the video data, at least a portion of the vehicle data, and at least a portion of the sensor data, and transmit the modified video file to a copilot management computer remote to the copilot device.

An embodiment of the disclosure is directed to a system comprising a copilot device and a copilot management computer. The copilot device having a memory including instructions that cause the copilot device to obtain disparate vehicle-related data comprising at least video data, sensor data, and vehicle data received via a connection with a vehicle, combine the disparate vehicle-related data into a single data file, and provide the single data file to a copilot management computer. The copilot management computer communicatively coupled with the copilot device and configured to process the single data file received from the copilot device. The system may further include a client device having installed upon it a mobile application, the mobile application enabling interaction between the client device and the copilot device.

The foregoing, together with other features and embodiments will become more apparent upon referring to the following specification, claims, and accompanying drawings.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 illustrates an example architecture that includes an after-market vehicle copilot device in accordance with at least some embodiments;

FIG. 2 depicts a block diagram showing various components of an exemplary system architecture that may be implemented to include a copilot device in accordance with various embodiments;

FIG. 3 depicts a block diagram of a number of exemplary hardware components that may be included within a copilot device in accordance with at least some embodiments;

FIG. 4A depicts an isometric top view of an exemplary copilot device;

FIG. 4B depicts an isometric side elevational view of an exemplary copilot device;

FIG. 4C depicts an isometric bottom view of an exemplary copilot device;

FIG. 4D depicts an isometric perspective view of an exemplary copilot device;

FIG. 5 depicts an isometric perspective exploded view of an exemplary copilot device;

FIG. 6 depicts multiple views of an exemplary copilot device having a detachable base that may be implemented in accordance with embodiments;

FIG. 7 depicts a flow diagram illustrating an example process for processing data via an exemplary copilot device in accordance with embodiments;

FIG. 8 depicts an example process for generating and providing a modified video file in accordance with embodiments;

FIG. 9 depicts an example process for automating vehicle functionality in accordance with embodiments;

FIG. 10 depicts an example graphical user interface that may be instantiated on a client device to enable interaction between a copilot device and the client device in accordance with at least some embodiments;

FIG. 11 depicts an example graphical user interface that may be instantiated on a client device to convey vehicle status information from a copilot device to a driver of the vehicle in accordance with at least some embodiments;

FIG. 12 depicts an example graphical user interface that may be instantiated on a client device to convey mileage information from a copilot device to a driver of the vehicle in accordance with at least some embodiments;

FIG. 13 depicts an example graphical user interface that may be instantiated on a client device to convey security event information from a copilot device to a driver of the vehicle in accordance with at least some embodiments; and

FIG. 14 depicts a flow diagram depicting an example process for generating and transmitting a modified video file to a server in accordance with at least some embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

This disclosure is directed to a system that includes a copilot device that can be installed as “aftermarket” within a vehicle in order to enable various functionality that would not typically be available for the vehicle. More particularly, the copilot device includes a number of cameras and sensors that collect information related to a vehicle in which the copilot device is installed. The copilot device is communicatively coupled with a Controller Area Network (CAN) bus of the vehicle via an onboard diagnostic (OBD) connection.

In some embodiments, the copilot device receives various disparate data types that include different sensor data collected by the sensors, video data (both internal and external to the vehicle), and vehicle data received via the OBD connection. The copilot device then combines at least a portion of the disparate data types into a data file by appending the sensor data and the vehicle data to the video data. In this data file, the disparate data types are synchronized based on a time at which each of the respective data is received. The data file is then provided to a backend server configured to process that data file.

In some embodiments, a backend server (e.g., a copilot management computer) uses the data file (and other data files received from other copilot devices) to train a machine learning model. A trained model generated in this manner may be provided back to the copilot device. Such a trained model, when implemented on the copilot device, may be used to determine appropriate actions to be taken when certain conditions are detected via the sensor and/or video data. These actions may then be taken independent of user involvement, causing certain vehicle functions to be automated.

In some embodiments, the system automatically detects beginnings and ends of business events on behalf of a user. The system is then able to generate mileage logs based on those business events in an accurate and efficient manner.

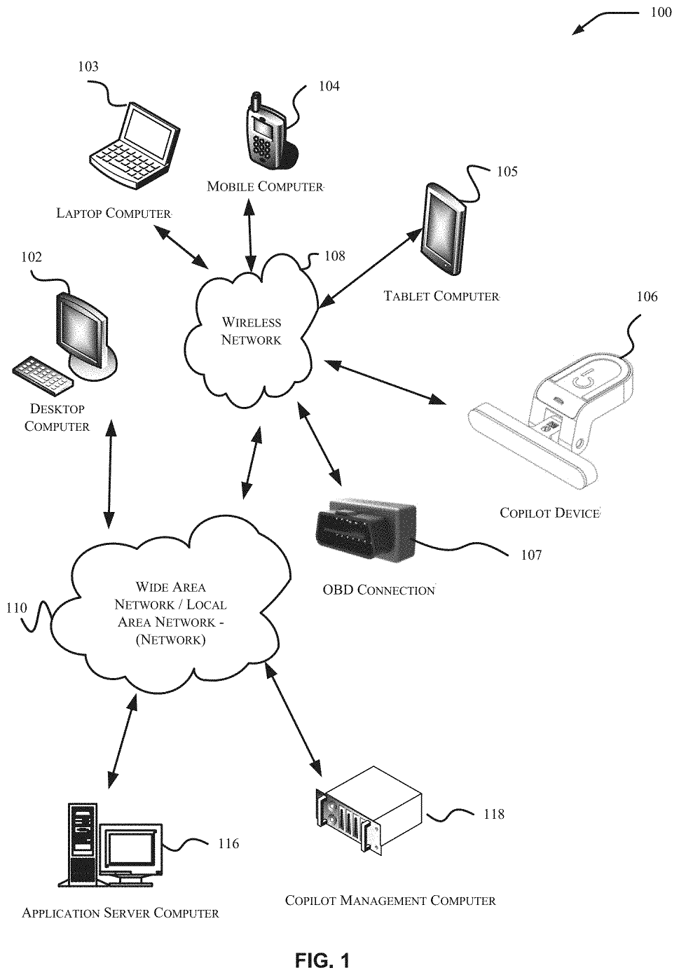

FIG. 1 illustrates an example architecture that includes an after-market vehicle copilot device in accordance with at least some embodiments. The vehicle copilot device of FIG. 1 includes at least a copilot device 106 and an on-board diagnostic (OBD) connection 107. The copilot device 106 facilitates installation in any existing vehicle manufactured after 1995 by coupling (for example, clamping, adhering, suction mounting, or other means) to a surface or component of the vehicle, such as the interior surface of a windshield or the top surface of a dashboard or motorcycle gas tank. For example, an adhesive strip on the top surface of the mount housing may facilitate mounting the copilot device 106 to the windshield of a vehicle. The copilot device 106 consists of hardware that includes a memory having one or more software modules that facilitate assisting or augmenting drivers' day-to-day tasks, such as tracking business-related mileage and/or activating vehicle functions.

The copilot device 106 communicates with one or more of the OBD connection 107, one or more client devices 102-105, an application server 116, and/or a copilot management computer 118. In some embodiments, the copilot device 107 communicates with one of the client devices 102-105 and/or the OBD connection 107 via a short-range wireless network 108, which may include communication means operating under a standard such as BLUETOOTH® or WI-FI®. In some embodiments, the copilot device 106 is communicatively coupled with one of the client devices 102-105 and/or the OBD connection 107 via a wire. In some embodiments, the copilot device 106 communicates with entities such as an application server 116 and/or a copilot management computer 118 via a wide area network 110 that includes a long-range wireless communication means, such as those operating under a standard such as LTE (a 4G mobile communication standard).

The copilot device 106 communicatively couples to an OBD connection 107. The OBD connection 107 is configured to interface with an on-board diagnostic bus that complies with OBD II standards, such as Society of Automotive Engineers (SAE) J1962. For example, the OBD connection 107 couples to the OBD-II connector port for vehicle diagnostics in the vehicle. In some embodiments, the OBD connection 107 may store a table of the various possible pin layouts associated with OBD or OBD-II connector ports and, most preferably, iteratively attempts to employ the stored pin layouts until one is deemed to correspond to the vehicle based on a successful use of a majority or all of the pins associated with the stored layout, thereafter storing an indicator of the successful stored layout being associated with the vehicle. In some versions, the user may select a pin layout, or the OBD connection 107 may select the pin layout based on an input of a vehicle year, make, or model from the user (the user inputs may be provided into an application executing on one of the client devices 102-105 that communicatively couples to the copilot device 106 or directly to the OBD connection 107). The OBD connection 107 obtains data from computers installed within a vehicle via the OBD or OBD-II bus and transmits that data (raw or modified) to the copilot device 106. In some embodiments, the copilot device 106 provides instructions to the OBD connection 107 to transmit instructions (raw or modified) to the vehicle computers to reset or otherwise modify one or more flags, codes, or statuses associated with the vehicle or to implement various functionalities of the vehicle.

The copilot device 106 includes computer-executable instructions (e.g., code) that are executable by the hardware (e.g., processors) of the copilot device 106. The copilot device 106 records both internal (rear facing) and external (front facing) videos in a loop as long as power is supplied. Based on the file count limit and video duration settings (e.g., 300 files and 3 minutes-long video by default), the oldest videos are replaced with newer videos in local memory when the file count limit is met. Additionally, video may be uploaded to the application server computer 116 or copilot management computer 118 as the video is captured. When one of the client devices 102-105 is used to connect with copilot device 106 via a communicative interface (wired or wireless) of the copilot device 106, various functionality may be enabled via a graphical user interface (GUI) of one of the client devices 102-105. For example, the user may browse thumbnails of recorded footage in the copilot device 106 that is available for download. The user may scroll to browse the footage and select footage for downloading to internal storage of one of the client devices 102-105. Once downloaded to one of the client devices 102-105, the user can select a different tab to browse or view the downloaded footage or upload the downloaded footage to a cloud account associated with the user, one of the client devices 102-105, or the copilot device 106. When uploaded to the cloud, the user can share the footage via email or a social network. In another example, the user may turn on or off the night vision for a camera via the software executing on one of the client devices 102-105.

The copilot management computer 118 provides backend support for the system described herein. For example, the copilot management computer 118 may provide full database and user authentication services to support the logic of the client devices 102-105 and copilot device 106. The copilot management computer 118 provides a highly scalable and robust serverless data upload system that handles user video uploads from many users simultaneously with an asynchronous processing queue. The copilot management computer 118 may provide push notifications to one of the client devices 102-105 that are facilitated by synchronization between the database and user authentication services. The push notifications inform the user via one of the client devices 102-105 on the start and finish of asynchronous processes and state changes in the overall system.

In some embodiments, the copilot management computer 118 is a cloud virtual machine (e.g., a virtual machine that executes an Ubuntu server). The copilot management computer 118 may facilitate Domain Name System (DNS) configuration that routes requests for a domain associated with the copilot management computer 118 to the IP address of the virtual machine. In some versions, backend logic is deployed to the server (for example, manually, with git hook, or ci/cd), and the service is refreshed. The copilot management computer 118 may maintain a database connection to a backing database. The copilot management computer 118 reads/writes data to serve application programming interface (API) requests and responses. In some embodiments, API calls are synchronous, with the exception of user video uploads. A video upload may be handled by an asynchronous worker queue running on the virtual machine.

In some embodiments, the application server computer 116 is a consumer of data generated by the copilot device and/or copilot management computer 118. The application server computer 116 may consume information about a vehicle in which the copilot device 106 is installed in order to provide functionality to the user. For example, the application server computer 118 may obtain mileage information from the copilot device 106 and may use that mileage information to generate tax documents. In some embodiments, the application server computer 116 may be operated by a third-party entity unaffiliated with the copilot management computer 118.

Various interactions may occur between the described components of the system 100. In the system 100, the copilot device 106 obtains vehicle data from the OBD connection 107. In some embodiments, the vehicle data may be obtained in predetermined intervals (e.g., every two seconds). The copilot device 106 stores the obtained data in local memory. The copilot device 106 also obtains video data from both a front-facing (external) camera as well as a rear-facing (internal) camera. The copilot device 106 also obtains data from one or more sensors of the copilot device. For example, the copilot device may obtain a temperature either inside or outside the vehicle, a location (e.g., via Global Positioning System (GPS) or Global Navigation Satellite System (GNSS)), acceleration data, real time data, or any other suitable information. The copilot device 106 may additionally receive information from one of the client devices 102-105. The copilot device may then combine the data into a single data stream. For example, the copilot device may append the information obtained from the sensors and/or the vehicle to the video as metadata. This synchronizes the information for easier retrieval and analysis, in that the information need not be aligned when analyzed.

The copilot device 106 then transmits the data to the copilot management computer 118 and/or application server computer 116. Various applications may then consume the data. By way of illustration, consider an example in which the driver of the vehicle is employed by a ride-hailing service (e.g., Uber, Lyft, etc.). In this illustration, the driver may use his or her vehicle for both work and personal driving at various times throughout the day. The user's client device 103-105 may include a mobile application that operates to provide ride service information to the user. The copilot device 106 may receive an indication of a ride service from one of the client devices 103-105 via an interaction with the mobile application. This may be combined with, among other pieces of data, odometer data obtained from the vehicle. When the combined information is provided to the copilot management computer 118, the copilot management computer 118 may identify the odometer data included throughout a video as well as an indication of what portions of the video relate to a business purpose (e.g., based on data received from the client device 103-105). In this way, the copilot management computer 118 can automatically track and delineate mileage for personal and business purposes and can provide a statement on demand (e.g., for tax purposes). It should be noted that while GPS location data could also be used to track mileage, such location data can often be inaccurate. For example, because of the periodic location reporting in GPS applications, distance is typically measured as a straight line between two detected locations. This can often lead to inaccuracies when a vehicle is making a number of turns, as the GPS application won't account for corners. The result is that the use of odometer data in the manner described may provide greater accuracy than the use of GPS location data when tracking mileage.

In some embodiments, the provided data may be used to train a machine-learning model (e.g., a machine-learning algorithm that uses a deep learning/cognitive network). For example, a machine-learning model may be trained to correspond user inputs from the vehicle data (e.g., turn on windshield wipers, turn on lights, etc.) to one or more video conditions. In this way, a trained machine-learning model may be created that is able to duplicate vehicle data appropriate to various conditions. This trained machine learning model may then be provided back to the copilot device 106. The copilot device 106 is then able to, upon detecting the various conditions via a current video feed, duplicate the user inputs via the OBD connection 107. This enables the copilot device 106 to “learn” and automate certain functions of the vehicle. By way of illustration, the copilot device 106 may determine, using the trained machine learning model, what level of windshield wiper activity should be activated based on rain that is detected in video captured from the front-facing camera. In a second illustration, the copilot device 106 may determine, using the trained machine learning model, at what threshold light level the vehicle headlights should be activated.

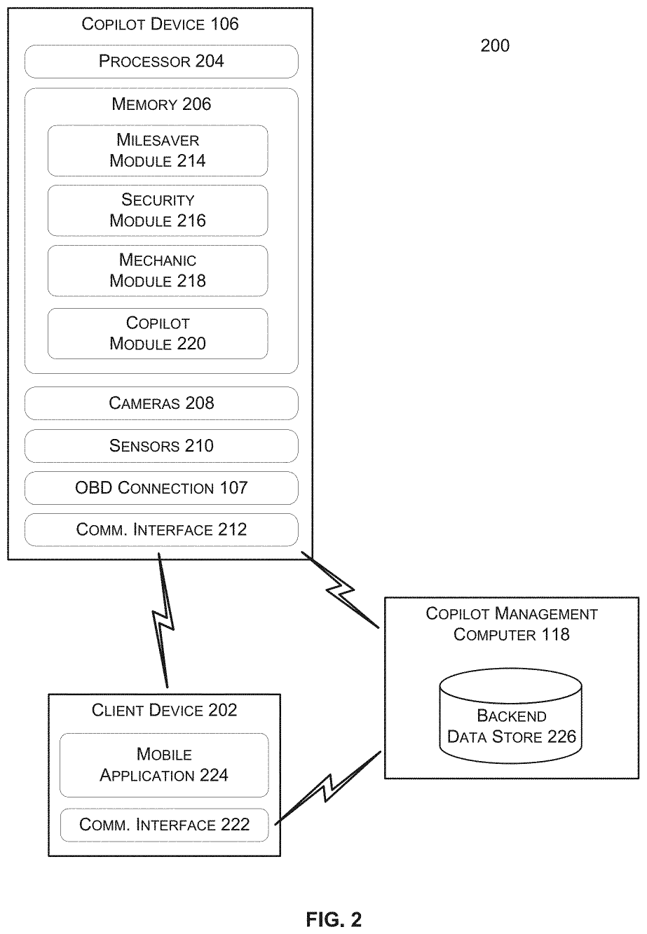

FIG. 2 depicts a block diagram showing various components of an exemplary system architecture that may be implemented to include a copilot device in accordance with embodiments of the disclosure. Included in system architecture 200 is a copilot device 106, a copilot management computer 118, and a client device 202. The copilot device 106 and copilot management computer 118 may be examples of respective copilot device 106 and copilot management computer 118 described with respect to FIG. 1. Client device 202 may be an example of one of client devices 102-105 as described with respect to FIG. 1.

The copilot device 106 may include a processor 204 and a computer readable memory 206. The processor 204 may be a central processing unit, and/or a dedicated controller such as a microcontroller. The copilot device 106 may further include one or more cameras 208, one or more sensors 210, an OBD connection 212, and a communication interface 214.

The one or more cameras 208 may include a rear-facing (internal) camera as well as a front-facing (external) camera. The rear-facing camera may capture video and/or images of a driver and passengers within the vehicle as well as an area outside and behind the vehicle (e.g., through the rear window of the vehicle). The front-facing camera may capture video and/or images of an area in front of the vehicle. In some embodiments, video obtained by one or more of the cameras may be processed via a neural network processor.

The sensors 210 may include any sensors capable of obtaining information about an environment in which the copilot device 106 is located. By way of non-limiting examples, sensors 210 may include a compass, an accelerometer, biometric sensors, a real-time clock, a temperature sensor, gyroscopes, magnetometer, and/or a global positioning system (GPS) sensor.

The OBD connection 212 includes a wireless OBD or OBD-II or wired connector coupled with a microcontroller (for example, PIC18F2480 microcontroller with Bluetooth low energy System on module). The OBD connection 212 facilitates both standard OBD-II PID protocol and direct read/write of CAN messages with a PCB that includes CAN transceivers (for example, SN65HVD233-HT). In some versions, the microcontroller manages data streams and wireless communications. The OBD connection 212 may include a standard female OBD connector at the opposite end of a male connector that plugs into the vehicle to make it possible for users to use multiple OBD connected modules at the same time. The OBD connection may couple with a Controller Area Network (CAN) bus of the vehicle.

The communication interface 214 may include wireless and/or wired communication transceiver components that enable the copilot device 106 to conduct long-range and short-range communication. Accordingly, the communication interface 212 may be used to transmit or receive data via a wireless carrier network, a local area network, a peer-to-peer network, etc. In some embodiments, the communication interface 212 may include a cellular modem that enables the copilot device 106 to perform telecommunication and data communication with a network, as well as a short-range transceiver that enables the device to connect to other devices via short-range wireless communication links. The copilot device 106 may further include signal converters, antennas, hardware decoders and encoders, graphics processors, a universal integrated circuit card (UICC), an eUICC, and/or the like that enable the copilot device 106 to execute applications and provide telecommunication and data communication functions.

The memory 206 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, DRAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms.

The one or more processors 204 and the memory 206 of the copilot device 106 may implement functionality from one or more software modules. Such software modules may include routines, program instructions, objects, and/or data structures that are executed by the processors 204 to perform particular tasks or implement particular data types. The one or more software modules may include a milesaver module 214 that automatically tracks and categorizes travel as being related to either personal or business, a security module 216 that captures and logs information pertaining to potential security threats, a mechanic module 218 that determines one or more potential vehicle issues, and a copilot module that automates at least a portion of a vehicle's functions.

The milesaver module 214 may be configured to track and categorize travel as being related to either personal or business. In some embodiments, the milesaver module 214 receives an indication of a business or personal tracking event. For example, the copilot device 106 may be in communication with a client device 202. In this example, the user might work for a ride hailing service (e.g., Uber, Lyft, etc.) and the client device 202 may be independently used by a user to interact with a mobile application for that ride hailing service. In this example, upon determining that a ride request has been accepted, the mobile application associated with the ride hailing service (or a widget or extension) may cause the client device 202 to indicate to the copilot device 106 that a business event has begun. The copilot device 106 may then indicate the beginning of the business event (e.g., via a timestamp or a marker appended to a data file). Similarly, the copilot device may also receive an indication of the end of the business event. Additionally, the milesaver module 214 obtains odometer data from the vehicle at regular intervals via the OBD connection 107. The odometer information may be determined at both the beginning and the end of the business event. The difference between the odometer information at the beginning and the end of the business event is then determined to be an amount of miles associated with the business event. The difference between the odometer information between business events is then determined to be an amount of miles associated with personal travel. In this way, the milesaver module 214 tracks both business and personal mileage in an accurate manner and without user involvement. In some embodiments, the milesaver module 214 may provide a log of business and/or personal travel details to the client device 202 or another device.

The security module 216 may be configured to capture and log information pertaining to potential security threats. In some embodiments, the security module 216 may capture video from the cameras 208 upon detecting one or more events. Such events may include a collision or impact with the vehicle, opening of a vehicle door, activation of a motion detector, or any other suitable event (e.g., via OBD connection 107). Upon detection of the event, the security module 216 may capture and transmit video or images from the cameras 208 to the copilot management computer 118. The video or images may be associated with a timestamp.

The mechanic module 218 may be configured to determine one or more potential vehicle issues. In some embodiments, the mechanic module 218 receives vehicle information via the OBD connection 107 that includes status information for the vehicle. In some embodiments, signals received via the OBD connection 107 may be interpreted based on a determined type of vehicle from which the signal is received. For example, the copilot device may store an indication of a type of vehicle in which the copilot device 106 is installed. Upon receiving a signal from the vehicle, the mechanic module 218 may map portions of the received signal to particular statuses within a status mapping based on the vehicle type. The mechanic module 218 may transmit the status information to the client device 202.

The copilot module 220 may be configured to automate at least a portion of a vehicle's functions. In some embodiments, the copilot module 220 may obtain various data that includes video and/or images from the cameras 208, data collected from the sensors 210, and vehicle data collected from the OBD connection 107, or other suitable data. The collected data is then combined into a single data file in which the data is aligned based upon a time at which the data is collected. A series of these data files may be generated. The copilot module 220 may provide these data files to the copilot management computer 118 for further processing. In some embodiments, the copilot module 220 may receive a machine learning model that has been trained on the provided data. In at least some of these embodiments, the trained machine learning model may be stored and used to automate various vehicle functions. For example, the machine learning model may be trained on various user actions (detected via the vehicle data collected over the OBD connection 107) taken as well as corresponding sensor data. By way of illustration, the system may detect that the user activates the vehicle headlights at a particular light level threshold. In this example, upon receiving the corresponding sensor data, the copilot device may automatically take the action that the user would normally take. This may involve replicating the signal to the OBD connection that is typically detected by the copilot device 106.

The client device 202 may be any personal device capable of interacting with at least one of the copilot device 106 or the copilot management computer 118 as described herein. The client device 202 may include a processor and a computer readable memory as well as a communication interface 216. The computer readable memory of the client device 202 may include a mobile application 218 that enables interaction between the client device 202 and the copilot device 106 and/or the copilot management computer 118. Execution of the mobile application 218 on the client device 202 may cause the client device 202 to instantiate a graphical user interface (GUI) associated with the mobile applications 218.

The mobile application 224 may enable a user of the client device 202 to interact with the copilot device 106. For example, a communication session may be established between the copilot device 106 and the client device 202 via the respective communication interfaces 222 and 216. In some embodiments, the mobile application 224 may provide a user with access to functionality provided via one or more modules implemented on the copilot management computer 118.

The copilot management computer 118 may be a computer or collection of computers that provides backend support for the copilot device 106 and the mobile application 224 installed on the client device 202. The copilot management computer 118 receives data from the copilot device 106 and stores at least a portion of that data in backend data store 226. The data received may include video data, vehicle information, and sensor data. The data stored in the backend data store 226 may be consumed by the copilot management computer 118 or by a third-party entity. In some embodiments, at least a portion of the data received at the copilot management computer 118 from the copilot device 106 is used to train a machine learning model that may then be implemented on the copilot device 106 in order to automate at least some functionality.

Note that while each of the modules 214-220 are depicted as being implemented on the copilot device 106, at least a portion of the functionality described with respect to those modules, or the modules themselves, may instead be implemented on the copilot management computer 118.

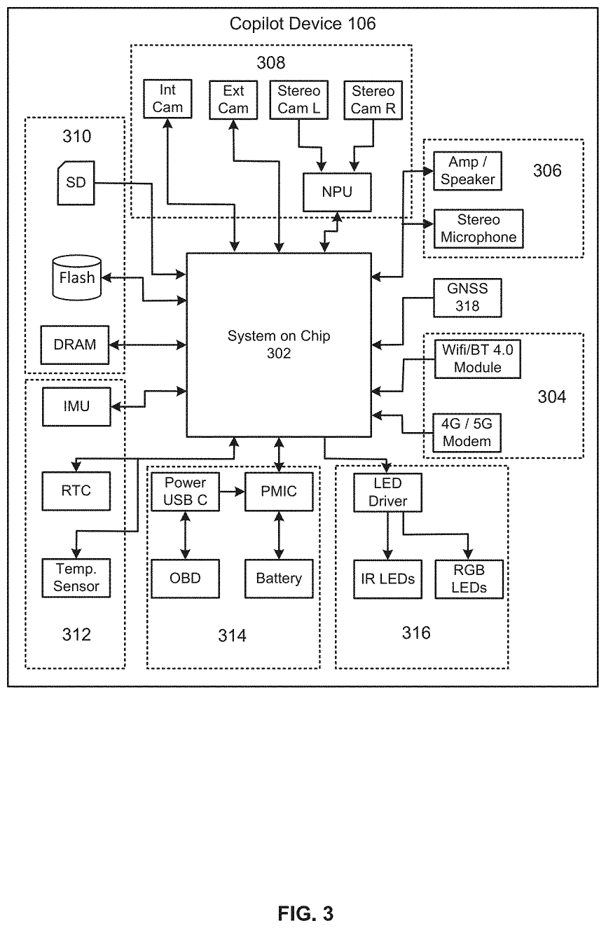

FIG. 3 depicts a block diagram of a number of exemplary hardware components that may be included within a copilot device in accordance with at least some embodiments. As depicted, the hardware components may include a system on chip (SOC) 302. Some non-limiting examples of a suitable SOC 302 may include a Raspberry Pi 3A+ board based on BCM2837B0 System on a Chip. The hardware components may include a number of components communicatively coupled to the SOC 302.

The SOC 302 is communicatively coupled with a wireless interface 304 to facilitate communicating with a client device or copilot management computer. The wireless interface 304 may include modules for implementing short-range communications (e.g., those that comply with wireless standards under the mark WI-FI®, or BLUETOOTH®) and modules for implementing long-range communications (e.g., those that comply with 4G wireless standards).

The SOC 302 is communicatively coupled with an audio interface 306 to provide information to a vehicle driver as well as to receive driver audio input. The audio interface 306 may include audio output components such as amplifiers (Amp) and speakers as well as audio input components such as a stereo microphone.

The SOC 302 is communicatively coupled with a camera interface 308 that includes a number of camera devices. In particular, the camera interface 308 includes at least an internal camera (Int Cam in FIG. 3) that captures video or imagery of the inside of the vehicle and an external camera (Ext Cam in FIG. 3) that captures video or imagery outside of the front of the vehicle. In some embodiments, the camera interface may include multiple external cameras. For example, the camera interface 308 may include off-center stereo cameras. In this example, the camera interface 308 may include left and right stereo cameras capable of capturing video imagery from an angle different from that of the external camera. In some embodiments, video or images captured via the stereo cameras may be processed using a neural net processor (e.g., a Mydriad X). A neural net processor is a computing processor unit (CPU) that is modeled around a human brain. Such embodiments significantly reduce the resources required to perform artificial intelligence functions (e.g., object recognition) on the video and images processed. In some embodiments, the multiple cameras of the camera interface 308 may be coupled to the SOC 302 using different means. For example, the one or more internal cameras may be coupled to the SoC via USB, whereas the one or more external cameras may be coupled to the SoC via MIIPI CSI.

The SOC 302 is communicatively coupled with additional memory 310. Memory 310 may include any suitable computer-readable medium, to include both volatile and non-volatile memory. By way of non-limiting example, the additional memory 310 may include flash memory or dynamic random access memory (DRAM). In some embodiments, the additional memory may include removable memory storage, such as a secure digital (SD) card.

The SOC 302 is communicatively coupled with a number of sensors 312. For example, the number of sensors 312 may include a temperature sensor, a real-time clock (RTC), an inertial measurement unit (IMU), or any other suitable sensor. An IMU may be any electronic device that measures and reports a body's specific force, angular rate, and sometimes the orientation of the body, using a combination of accelerometers, gyroscopes, and sometimes magnetometers.

The SOC 302 is communicatively coupled with a power module 314 that provides power to the copilot device 106. The power module 314 may include a power management integrated circuit (PMIC) that manages power provided to the copilot device 106. In some embodiments, power may be supplied to the copilot device 106 from an OBD connection, such as OBD connection 107 described with respect to FIG. 1. The PMIC may connect to the OBD connection via a power USB cord. In some embodiments, the power module 314 may include a battery or other backup power source. In some cases, the battery may be charged with power from the OBD connection and may provide power to the copilot device 106 when the copilot device 106 is disconnected from the OBD connection.

The SOC 302 is communicatively coupled with a light output module 316 that outputs status indicators. The light output module 316 may include a light-emitting diode (LED) driver. In some embodiments, the light output module 316 may include a number of different kinds of LEDs. For example, the light output module 316 may include infrared (IR) LEDs capable of illuminating passengers with IR light. In another example, the light output module 316 may include red green blue (RGB) light LEDs that provide a status indication to the user. In some embodiments, the LED components are controlled by pins of the SOC 302 (for example, GPIO pins).

The SOC 302 is communicatively coupled with a Global Navigation Satellite System (GNSS) module 318. The GNSS module provides location data to the SOC 302.

In one non-limiting example, the SOC 302 of the copilot device 106 executes a Debian-based Linux distro called Raspbian built for Raspberry Pi (for example, an embedded Linux board). In other versions, a Distro may be configured using the Yocto project. In some versions, loaded scripts (for example, python scripts) may include one or more of camera, thumbnail, garbage collector, or server scrips. In some versions, the scrips are executed or managed as systemd services that facilitate various. Besides various APT and pip packages that these scripts execute, the code deployment process includes configuring various Linux daemon software and tools. Hostapd configuration facilitates the copilot device 106 broadcasting its own wireless network with which a client device may connect. In some versions, bluez.service or rfcomm rules are set to configure connection between the OBD connection and the copilot device 106.

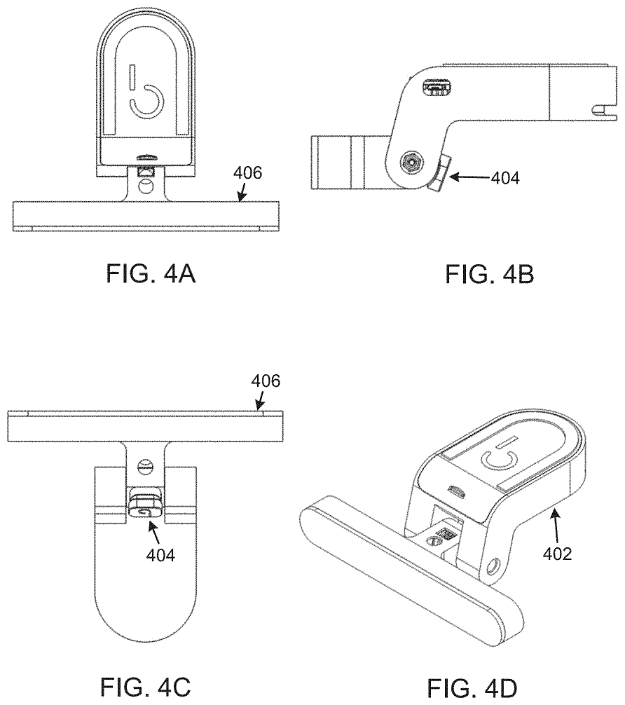

FIG. 4 depicts several different views of an exemplary copilot device that may be implemented in accordance with embodiments. More particularly, FIG. 4A depicts an isometric top view of an exemplary copilot device. FIG. 4B depicts an isometric side elevational view of an exemplary copilot device. FIG. 4C depicts an isometric bottom view of an exemplary copilot device. FIG. 4D depicts an isometric perspective view of an exemplary copilot device. The exemplary copilot device 106 depicted in FIG. 4 is an example of copilot device 106 described with respect to FIG. 1.

The exemplary copilot device 106 includes a main housing 402. The main housing 402 couples to a pre-existing vehicle (for example, a pre-owned vehicle, or a vehicle that has been purchased and driven away from a dealership). The main housing 402 is coupled to an internal camera assembly 404 and an external camera assembly 406. The internal camera assembly 404 includes at least one camera. The external camera assembly 406 includes one or more additional cameras (for example, two, three, or more cameras) and one or more infrared light emitting diodes (LEDs) that facilitate night vision.

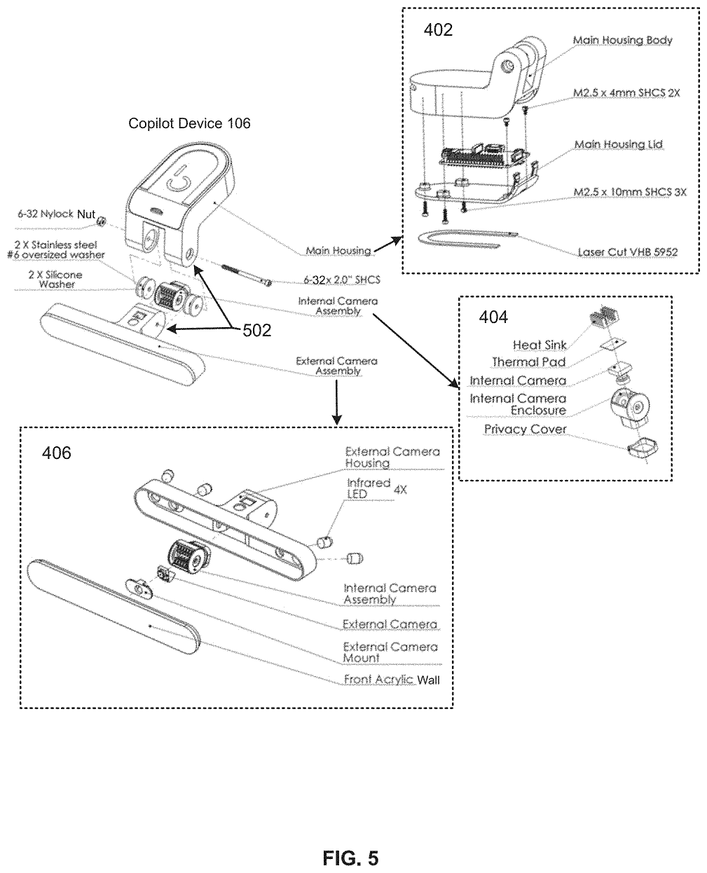

FIG. 5 depicts an isometric perspective exploded view of an exemplary copilot device. More particularly, FIG. 5 depicts exploded views of each of the main housing 402, internal camera assembly 404, and external camera assembly 406. As depicted in FIG. 5, each of the main housing 402, internal camera assembly 404, and external camera assembly 406 may be connected via a hinge 502.

The main housing 402 and the camera assemblies 404 and 406 are hingeably coupled to each other to facilitate adjusting the angle of the camera assemblies 404 and 406 relative to the main housing after the main housing 402 has been coupled to the vehicle. In some versions, the camera assemblies 404 and 406 are separably and hingeably coupled to the main housing 402 to facilitate mounting the camera assemblies 404 and 406 in multiple different vehicles that have a respective main housing 402 mounted therein. For example, a hinge 502 may be defined by one or more of a first component of the main housing 402 and a second component of a camera assembly 404 or 406, with the first and second components being separably coupled to each other (for example, snaps, magnets, pins, or others). The first and second components have corresponding electrical contacts that facilitate transferring data and power between the camera assemblies 404 or 406 and the main housing 404 and 406 without requiring the user to connect or disconnect any wires or wire terminals. Note that in some embodiments, the copilot device 106 may be devoid of external wires.

In some embodiments, each of the main housing 402, internal camera assembly 404, and external camera assembly 406 may be connected via a hinge 502 in a manner such that the internal camera assembly 404 can be rotated or otherwise adjusted independent of the external camera assembly 406. Rotational friction for the hinge 502 is made adjustable via manipulation of a component of the hinge that increases or decreases friction forces in the hinge (for example, 6-32 socket head cap screw (SHCS) running axially through the center of the hinge and held in place with 6-32 Nylock nut). In some versions, rotational friction related to the orienting of the one or more external-facing cameras within external camera assembly 406 is increased and regulated through mating steel and silicone washers as a bearing surface. In some embodiments, steel washers are adhered to the main housing side of hinge and silicone washers are adhered to the external camera assembly side of hinge. Rotational friction related to the orienting of the one or more internal-facing cameras within internal camera assembly 404 is decreased and regulated through mating a nylon washer with fitted plastic (e.g., plastic that is 3D printed using MultiJet Fusion Nylon or Polyethylene Terephthalate Glycol (PETG)). Nylon washers are press fit into the outside of the internal camera assembly 404 enclosure. In some versions, the hinge 502 is a pin hinge.

One or more of the main housing 402 or the camera assemblies 404 and 406 of the copilot device 106 includes logic-executing circuitry (e.g., the hardware components described with respect to FIG. 3). One or more of the main housing 402 or the camera assemblies 404 and 406 includes a power source (for example, a battery charger to charge the battery from an external power source, or a power converter that couples to a power source in the vehicle). In some embodiments, the OBD connection may also act as the power source in that power for the copilot device is drawn from the vehicle through the on-board diagnostic bus. In some embodiments, RGB LEDs may be disposed within the main housing to facilitate communicating device status or other information (for example, lane drift notifications, theft prevention, or burglary notification based on evaluation of the video data) to the user. In some embodiments, the copilot device 106 is devoid of any display or user-interface controls (for example, tactile buttons or other controls) to facilitate reducing driver distractions.

A main housing lid is coupled to the main housing body (for example, coupled using 2 M2.5×10 mm SHCS and clips). The lid of the main housing may include one or more mounts that facilitate coupling the copilot device 106 to a vehicle (for example, a piece of laser cut 3M Very High Bond (VHB) adhesive, such as foam tape, that mounts the copilot device 106 to the windshield of the vehicle). The amount of adhesive is minimized to make mounting and removal from the vehicle easier and to reduce air bubbles when mounted to the windshield and leave a logo visible through the windshield.

Internal camera assembly 404 houses one or more rearward-facing internal cameras that facilitate recording video of activity internal to the vehicle and also external to the vehicle opposite the direction of the vehicle's travel when moving forward (e.g., out the rear window of the vehicle). The rearward-facing camera may be a wide-angle camera. In some versions, the internal camera, a thermal pad, and a heat sink are mounted on the inside of the camera assembly 404 and secured by a component of the hinge 502, such as an axial 6-32 SHCS. Washers are mounted on the sides of the enclosure of the internal camera assembly 404.

External camera assembly 406 houses one or more forward-facing external cameras that facilitate recording video of activity external to the vehicle in the direction of the vehicle's travel when moving forward. In some embodiments, an external camera housing of external camera assembly 406 includes a front wall (for example, an acrylic wall) that defines a front surface of the camera housing. The front wall is translucent or transparent to the forward-facing external cameras. The front wall may have a machined lip around its perimeter, with the lip interfacing with the body of the camera housing to facilitate coupling the front wall to the body of the camera housing. The interior of the camera housing may be painted or otherwise colored with a dark color (e.g., black) to limit light interference. A mount for each camera is coupled (for example, adhered) to the inside of the camera housing, such as an interior surface of the front wall. In some versions, one or more rear surfaces of the camera housing define a hole for each infrared LED (for example, 4 holes that fit 850 nm infrared LEDs) oriented at respective angles to maximize spread of infrared light across all passenger's faces. Holes defined by the camera housing may be located on the top near the camera housing in order to facilitate passing wires from the external camera assembly 406 to the main housing 402.

In some embodiments, one or more of the camera housing or the main housing includes materials that facilitate having the one or more housings act as a heat sink. For example, the one or more housings may be formed of anodized aluminum to facilitate the one or more housings acting as a passive heat sink.

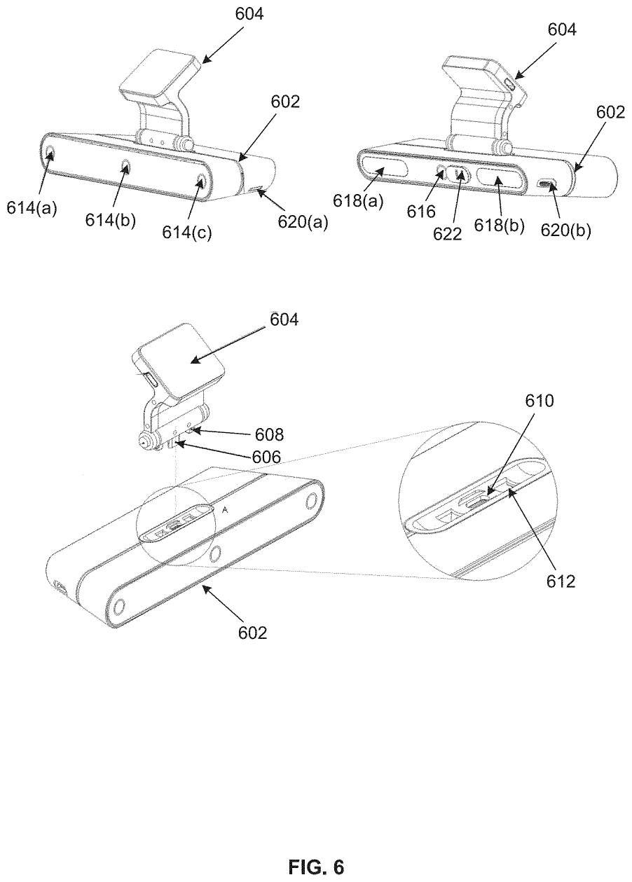

FIG. 6 depicts multiple views of an exemplary copilot device having a detachable base that may be implemented in accordance with embodiments. In some embodiments, the copilot device may consist of a main housing 602 that includes at least a portion of the hardware components as well as a base component 604 that mounts to a vehicle.

In at least some embodiments, the main housing 602 may be removably connected to the base component 604. For example, the main housing 602 and the base component 604 may be connectable via a male data port connector 606 and securing latches 608 that connect to a corresponding female data port connector 610 and latch impressions 612. This allows the main housing 602 to be removably connected to the base component 604 such that the base component 604 can be mounted semi-permanently within a vehicle and the main housing can be removed from the vehicle at will. This advantageously enables the user of the copilot device to remove the main housing from the vehicle in order to prevent its theft as well as to use a single main housing 602 with multiple vehicles that each include an installed base component 604.

As depicted in FIG. 6, the main housing 602 may include a number of hardware components described with respect to FIG. 3 above. For example, a front-facing side (e.g., a side that faces the front of the vehicle) of the main housing 602 may include a number of external cameras 614 (a-c) configured to capture video or images from outside the front of the vehicle. External cameras 614 (a-c) may correspond to the external camera and stereo cameras (L and R) described with respect to FIG. 3 above. It should be noted that the use of multiple front-facing cameras 614 (a-c) enables the copilot device to use various depth-sensing techniques that might not otherwise be available via the use of a single camera.

In another example, a rear-facing side (e.g., a side that faces the interior of the vehicle) of the main housing 602 may include an internal camera 616 configured to capture video or images of an interior of the vehicle, to include one or more people within the vehicle (e.g., a driver and/or passengers). Internal camera 616 may correspond to the internal camera described with respect to FIG. 3 above. In some embodiments, the rear-facing side of the main housing 602 may also include IR LED emitters 618 (a-b) configured to emit infrared light into the interior of the vehicle. In these embodiments, the internal camera 616 may be capable of capturing video or images using this infrared light, enabling such imagery to be captured in scenarios in which there is little natural light present (e.g., at night).

In some embodiments, the main housing 602 may include ports 620 (a-b) or other connection means that enable additional electronic devices, modules, and/or sensors to be connected to the copilot device. Data received via these ports 620 (a-b) may be processed in a manner similar to data received from the sensors included in the copilot device. The copilot device may also include a power button 622 that causes the copilot device to be powered on or off.

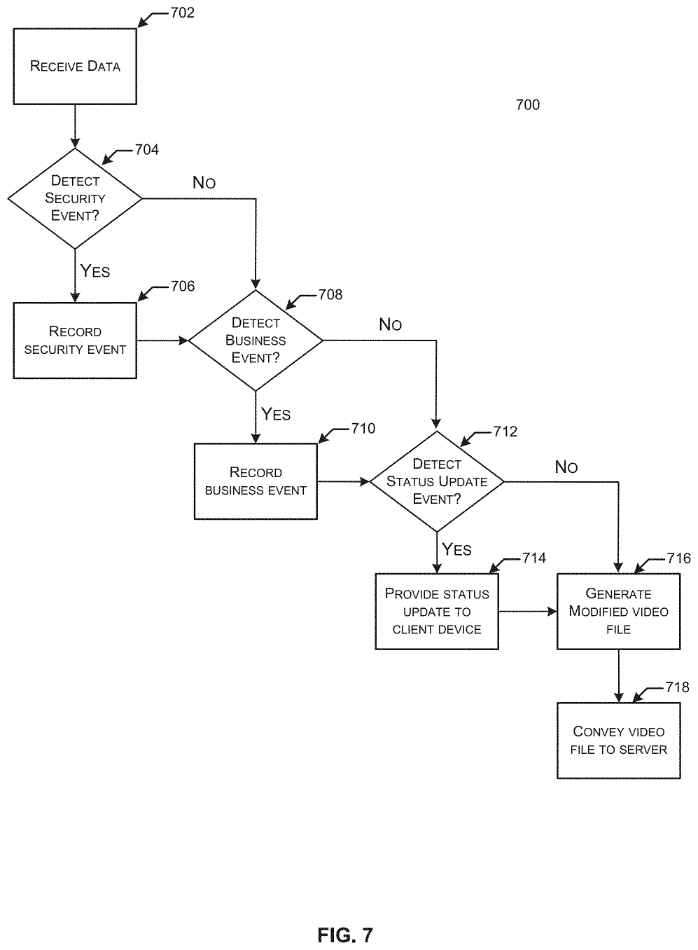

FIG. 7 depicts a flow diagram illustrating an example process for processing data via an exemplary copilot device in accordance with embodiments. The process 700 is illustrated as a logical flow diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be omitted or combined in any order and/or in parallel to implement this process and any other processes described herein.

Some or all of the process 700 (or any other processes described herein, or variations and/or combinations thereof) may be performed under the control of one or more computer systems configured with executable instructions and may be implemented as code (e.g., executable instructions, one or more computer programs or one or more applications). In accordance with at least one embodiment, the process 700 of FIG. 7 may be performed by one or more elements of the copilot system shown in FIG. 1. For example, the process 700 may be performed by a copilot device 106 as described with respect to FIG. 1. The code may be stored on a computer-readable storage medium, for example, in the form of a computer program including a plurality of instructions executable by one or more processors. The computer-readable storage medium may be non-transitory.

At block 702, process 700 comprises data being received by the copilot device. In some embodiments, the data may include information received from a vehicle in which the copilot device is installed (e.g., via an OBD connection), sensors included within the copilot device, and cameras included within the copilot device. In some embodiments, data may be received on a constant basis. For example, the copilot device may continue to receive video data from one or more of its cameras as long as the device is connected to a power source (even when a vehicle in which it is installed is shut off). The data may be processed as it is received in order to identify particular events. In some embodiments, this involves comparing one or more conditions identified from the data to conditions indicative of a particular type of event in order to detect that particular type of event.

At decision block 704, the process 700 comprises detecting a security event by determining whether one or more conditions identified from the received data matches conditions indicative of such a security event. For example, the copilot device may store an indication of one or more conditions that indicate a potential security event. Such events may include, by way of non-limiting example, an opening of one or more doors of the vehicle (as detected via a door open indicator signal received via the OBD connection) when no key is present, a movement of the vehicle when the vehicle is unpowered (which may indicate a collision or impact), a received sound signal that shares a high degree of similarity with a sound of breaking of glass, activation of a motion detector, or any other suitable indication of a potential security breach of the vehicle. It should be noted that the copilot device may detect security events even if the vehicle is currently off

At block 706, upon detecting a potential security event (“yes” from the decision block 704), the process 700 comprises recording the potential security event. This may involve capturing video from the internal camera and/or external camera and modifying the video to include a current time as well as other information (e.g., a security issue type). The record of the security event (e.g., the modified video) is then stored in the copilot device, transmitted to a client device, and/or transmitted to a copilot management computer. The record of the security event may be transmitted to another electronic device right away or at a later point in time. For example, the record of the security event may be stored on the copilot device until it is downloaded, or it may be transmitted to another electronic device in real time (e.g., as the security event is occurring). If no potential security event is detected, then the process may continue to block 708 without recording a security event (“no” from the decision block 704).

At decision block 708, the process 700 comprises detecting a business event by determining whether one or more conditions identified from the received data matches conditions indicative of such a business event. For example, the copilot device may store an indication of one or more conditions that indicate a business event. Such events may include, by way of non-limiting example, an indication of a business event received from a mobile application executed on a client device, a manual indication input to the copilot device by a user (e.g., a push of a button on the copilot device), a determination that the vehicle is currently taking a route commonly linked to a business event (e.g., a taxi driver is currently driving toward an airport), or any other suitable indication that the driver is engaged in a business event. In some embodiments, a business event may include both a business event start and a business event end. Detecting a business event may involve detecting both the start and the end of a business event, which may each be associated with different conditions.

At block 710, upon detecting a business event (“yes” from the decision block 708), the process 700 comprises recording the business event. This may involve obtaining and recording a current odometer reading at a time associated with a business event start as well as recording a current odometer reading at a time associated with a business event end. The business event may further include an indication of a timestamp, location (e.g., via GPS), video, or other data. The recorded business event is then stored in the copilot device, transmitted to a client device, and/or transmitted to a copilot management computer. In some embodiments, the record of the business event is transmitted to another electronic device either when requested or in real time. If no business event is detected, then the process may continue to block 712 without recording a business event (“no” from the decision block 708).

At decision block 712, the process 700 comprises detecting a status update event by determining whether one or more conditions identified from the received data matches conditions indicative of such a status update event. In this scenario, the copilot device may determine a status of the driver or vehicle based on the received data. Each status may be associated with particular conditions. Numerous types of statuses may be associated with a vehicle and/or user.

For example, a copilot device may receive an indication of a speed limit associated with a current stretch of road on which the vehicle is located. In this example, the copilot device may also receive an indication of a current speed at which the vehicle is traveling (e.g., via the OBD connection). Based on this information, the copilot device may identify a speeding status for the vehicle if the copilot device determines that the current speed of the vehicle is greater than the speed limit for the current stretch of road. Alternatively, the copilot device may identify a heavy-traffic status for the vehicle upon determining that the current speed of the vehicle is sufficiently lower than the speed limit for the current stretch of road. In some cases, a heavy-traffic status determination may require a determination that the current speed of the vehicle is sufficiently lower than the speed limit as well as identification of one or more vehicles in obtained video data.

In a second example, the copilot device may receive an indication of one or more issues associated with the vehicle. For example, the copilot device may receive an error code transmitted to the copilot device via the OBD connection. In this example, the copilot device may translate the error code to an issue status based on a mapping stored in relation to a particular type or brand of the vehicle in which the copilot device is installed.

At block 714, upon detecting a status update (“yes” from the decision block 712), the process 700 comprises providing the detected status to a client device. For example, the copilot device may transmit the status to the driver's mobile device. The status may then be presented to the user via a GUI executed on the mobile device. If no status update event is detected, then the process may continue to block 716 without recording a status update event (“no” from the decision block 712).

At block 716, the process 700 comprises generating a modified video file. This may involve appending the received data to a video file captured by one or more cameras included in the copilot device. In some cases, this comprises appending at least a portion of the received data to a footer of the video as metadata. The received data may be associated with a timestamp indicating a time at which the data was received. In this way, various types of data may be aligned via timestamp.

At block 718, the process 700 comprises conveying the modified video file to a server. In some embodiments, the server may be a copilot management server as described with respect to FIG. 1. The modified video file may be consumed by various different applications. In some embodiments, the server may provide the modified video file to a machine learning module to be used in training a machine learning model.

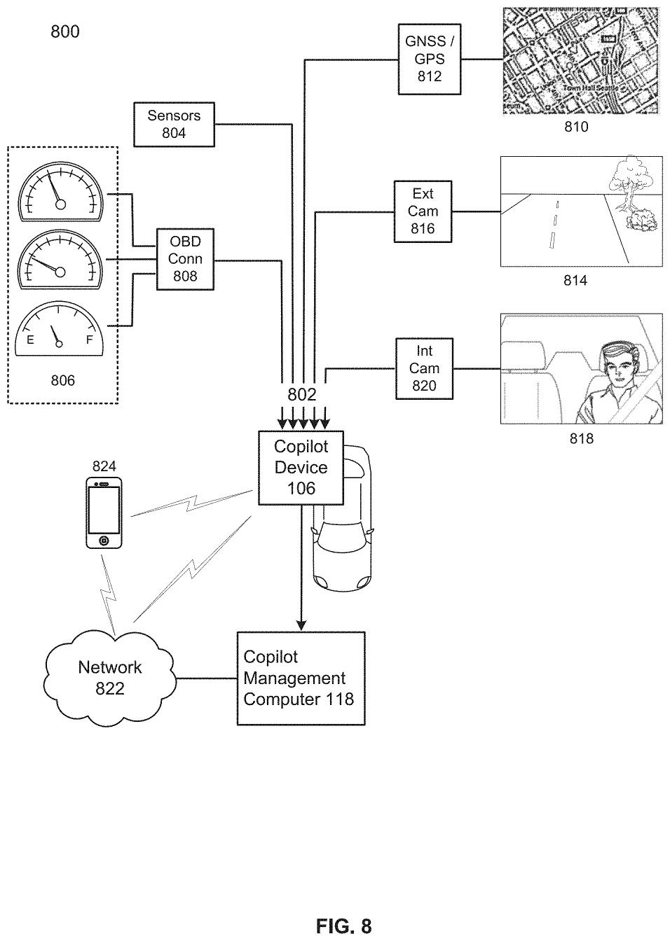

FIG. 8 depicts an example process for generating and providing a modified video file in accordance with embodiments. In the illustrated process 800, information 802 may be received by a copilot device 106 from a number of different sources communicatively coupled to the copilot device 106. The information 802 may include a variety of information types.

In some embodiments, the information 802 may include sensor data received from one or more sensors 804. For example, the information 802 may include data obtained from a temperature sensor (e.g., a thermometer), a real-time clock, accelerometers, gyroscopes, magnetometers, or any other suitable types of sensors. The information includes vehicle data 806 that may be received over an OBD connection 808. Vehicle information 806 may include odometer information, speedometer information, error code information, or any other suitable vehicle data.

In some embodiments, the information 802 may include location information 810 obtained from a GNSS or GPS device 812. The location information 810 may be obtained periodically (e.g., every five minutes).

In some embodiments, the information 802 may include video data. Video data may include external video 814 captured by an external camera 816 directed out the front of a vehicle. Video data may also include internal video 818 captured by an internal camera 820 directed toward the inside of the vehicle.

Upon receiving the information 802 from a variety of sources, the copilot device 106 may compile the received information 802 into a single data file in which each of the data is aligned based on a time at which it was received. In some embodiments, one or more pieces of data may be attached to a video file. For example, the data may be added as metadata to a footer of the video. Each piece of data may be associated with a particular time within the video, such that data is caused to be synchronized using a time in the video. This allows the data to be processed in a much more efficient manner, in that a consumer of the data file need not align the data during its processing.

The generated data file is then conveyed to a copilot management computer 118. In some embodiments, the data file is provided to the copilot management computer 118 over a network 822 directly via a long-range communication means included in the copilot device 106. In some embodiments, the data file is provided to the copilot management computer 118 via a short-range communication means included in the copilot device 106 using a client device 824 as a proxy. In this embodiment, the data file is transmitted to the client device 824, which then forwards the data file to the copilot management computer 118 via the network 822.

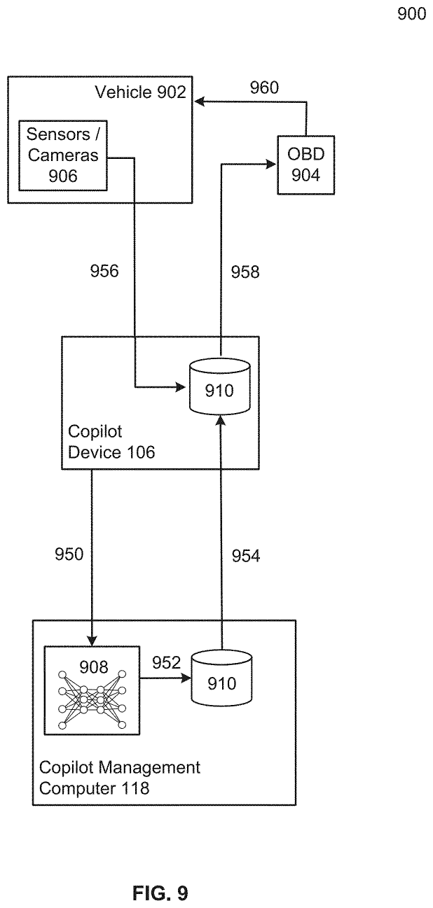

The copilot management computer 118 is then able to process the data file in order to perform one or more functions. In some embodiments, the copilot management computer 118 uses the data file (along with data files provided by other copilot devices) to automate certain vehicle functions. This process is described in greater detail below with respect to FIG. 9. In some embodiments, one or more services may be provided based on the received data file. Some non-limiting examples of services that may be provided based on the data file are provided below.

In a first example, the copilot management computer 118 may determine traffic patterns from data files received from a number of copilot devices. In this example, the copilot management computer may receive a recent data file from a copilot device that indicates a speed of the vehicle is significantly lower than a posted speed limit for a road that the copilot device is currently traveling on (e.g., based on a location of the copilot device and a mapping of posted speed limits). In this example, the copilot management computer 118 may perform object recognition on a video in the data file to determine the presence of a number of vehicles around the copilot device. Based on the determined presence of several vehicles, and the speed at which the copilot device is traveling, the copilot management computer 118 may associate a heavy-traffic status with the current location of the copilot device. The copilot management computer 118 may provide an indication of heavy-traffic locations to a number of copilot devices to enable drivers associated with those copilot devices to avoid the heavy-traffic locations. In some embodiments, an indication of a heavy-traffic location may be provided to a copilot device determined to be traveling toward that heavy-traffic location.

In another example, the copilot management computer 118 may identify a number of parking space locations appropriate for various vehicles. In this example, the copilot management computer 118 may process video received in the data file to identify available parking spaces. Such parking spaces may be identified using object recognition (to identify vehicles) as well as depth sensing techniques (to determine the size of a space between vehicles). It is envisioned that depth sensing techniques may use data obtained from a depth sensor. However, given the distance at which such a depth must be calculated, conventional structured light depth sensing may be ineffective. Instead, the copilot device may compare video captured from different angles (e.g., video captured from stereo cameras 614 (a-c) of FIG. 6) to determine a depth (distance) between various parked vehicles. To do this, the copilot management computer 118 determines a distance between the copilot device and a first point at the rear of a first parked vehicle as well as a distance between the copilot device and a second point at the front of a second parked vehicle at a particular time within the video. A distance between the two parked vehicles can then be determined using the two calculated distances and an angle for each of the two points respective to the copilot device (which may be determined based on a location of the two points within the video image). In this way, the copilot management computer 118 can identify potential parking spaces based on a size and location of spaces between parked vehicles as a copilot device travels along a road. The copilot management computer 118 then identifies valid parking spaces by eliminating any potential parking spaces that are collocated with obstructions (e.g., driveways, fire hydrants, no parking zones, etc.) based on a stored mapping of obstruction locations as well as potential parking spaces that are below a threshold size. Once valid parking spaces have been identified, the copilot management computer 118 may transmit parking space data to at least one copilot device (which may be different from the copilot device from which the data file was received). In some embodiments, the copilot management computer 118 only provides parking space data to a copilot device installed in a vehicle that can fit within the parking space. For example, a copilot device installed within a large vehicle may be provided with a smaller list of parking spaces than a copilot device installed within a small vehicle.

FIG. 9 depicts an example process for automating vehicle functionality in accordance with embodiments. The process 900 may involve interactions between a number of components of a copilot system. For example, the process 900 may involve interactions between a copilot device 106, a copilot management computer 118, and a vehicle 902. Interactions between the copilot computer 106 and the copilot management computer 118 may be facilitated via a network connection whereas interactions between the copilot device 106 and a vehicle may be facilitated via an OBD connection 904. The copilot device 106 may collect information about the vehicle 902 using communicatively coupled sensors and cameras 906.

In the example process 900, data is transmitted from the copilot device 106 to the copilot management computer 118 at 950. An example process for generating such data is provided above with respect to FIG. 8. In some embodiments, data may be received from a number of different copilot devices 106 associated with a number of different users and/or vehicles 902. The data received by the copilot management computer 118 may be used to train a machine learning algorithm 908. For example, a first portion of the data may be provided to the machine learning algorithm as inputs and a second portion of the data may be provided to the machine learning algorithm as inputs. By way of illustration, if the machine learning algorithm is a neural network, various video features (e.g., identified objects, light level, etc.) and sensor data from the data may be provided to the neural network as an input layer whereas data indicative of user actions (e.g., turn on lights, set speed of windshield wipers, etc.) may be provided as an output layer. In this manner, the machine learning algorithm 908 may be trained at 952 on appropriate user responses to various inputs to generate a trained model 910. Once a trained model 910 has been generated by the copilot management computer 118, the copilot management computer 118 may provide that trained model 910 to a copilot device 106 at 954, which stores the trained model 910 in memory.

Once the copilot device 106 has received a trained model 910, the copilot device 106 may automate functionality of the vehicle 902 using that trained model 910. For example, the copilot device may receive data from one or more sensors and cameras 906 pertaining to operation of a vehicle 902 at 956. Upon receiving this data, the data may be provided to the trained model 910, which is then configured to generate instructions to be provided to the vehicle 902 based on the received data. In some embodiments, the generated instructions may be specific to a particular type of vehicle 902 in which the copilot device 106 is determined to be installed.

Instructions generated using the trained model 910 are provided to the vehicle in order to cause it to take some action. More particularly, the generated instructions are provided to the OBD connection 904 at 958. The OBD 904 then translates those instructions into signals to be transmitted to the vehicle at 960 to cause certain actions to be taken by the vehicle. For example, the instructions provided at 958 may include instructions to turn on the vehicle's headlights. In this example, the OBD connection 904 may determine an appropriate pin on a connection bus that controls vehicle lights and may provide a signal to the vehicle via that pin at 960.

Using the techniques described above, the copilot device 106 can be made to automate the activation of certain vehicle functions. As would be recognized by one skilled in the art based on the description of FIG. 8 and FIG. 9 above, the copilot device 106 collects information about the vehicle's environment (e.g., via the sensors and camera 906) as well as information about actions that the user has taken (e.g., vehicle information collected from an OBD connection) and generates a single data file in which the data is synchronized based on time. This enables a machine-learning model to identify actions taken by a user that correspond to various conditions detected in the environment data using a machine-learning algorithm. A model 910 trained on such data can be made to recognize user actions that are appropriate when certain conditions are present in the environment. The copilot device 106, when provided this trained model 910, can then automatically simulate signals that would normally be generated by user actions upon detecting those environmental factors. For example, if users typically turn on the headlights when the ambient light level falls below a certain light level threshold, then a trained model may identify that light level threshold and that action of a user in turning on the headlights. In this example, a copilot device that has been provided that trained model may, upon detecting that a current ambient light level has fallen below the light-level threshold, provide an instruction to the OBD connection, which then generates a signal that would typically be generated when the user activates the vehicle headlights, causing the vehicle headlights to be activated automatically (e.g., without user interaction).

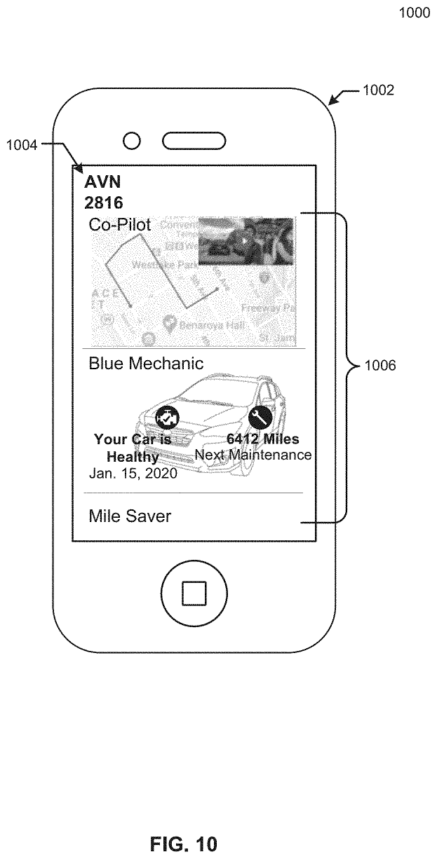

FIG. 10 depicts an example graphical user interface that may be instantiated on a client device to enable interaction between a copilot device and the client device in accordance with at least some embodiments. More particularly, FIG. 10 depicts a client device 1002 on which a user interface for a mobile application is instantiated.

In some embodiments, a user may access an account associated with the mobile application (e.g., via a login and password). The account may be unique to the user and may be associated with a unique identifier 1004. In some embodiments, the account may be associated with (e.g., paired with) one or more particular copilot devices. Data provided to the mobile application may be provided directly to the client device 1002 from an associated copilot device or it may be provided from a copilot device to a backend server (e.g., copilot management computer 118) and then routed to the client device 1002 by the backend server based on the account information.

In some embodiments, the mobile application may cause the client device 1002 to receive data from the copilot device via a short-range wireless connection. The graphical user interface may present a portion of that received data 1006 to a user of the client device 1002. In some embodiments, data 1006 may include a menu of functionality available to the user of the client device 1002.

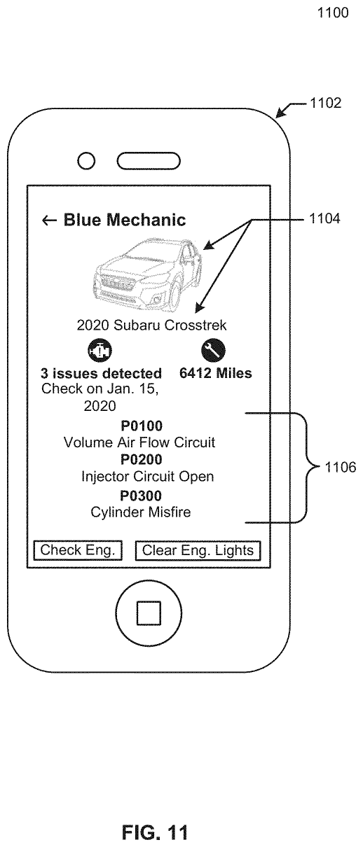

FIG. 11 depicts an example graphical user interface that may be instantiated on a client device to convey vehicle status information from a copilot device to a driver of the vehicle in accordance with at least some embodiments. In some embodiments, a mobile application installed on the client device may include a mechanic assistance module that presents the received vehicle status information. When the mechanic-assistance module executes on the client device, data obtained from an OBD connection is transferred from the copilot device 106 to the client device, either automatically or responsive to the user selecting a user-interface control that causes the copilot device to obtain the data. In some versions, an HTTP request may be transmitted to the copilot device 106 to cause the copilot device 106 to initiate a request to the OBD connection to obtain the data and transmit the obtained data to the copilot device 106, which then provides the data to the client device.

In some embodiments, the mechanic-assistance module provides metrics based on the obtained data, such as metrics that indicate vehicle component health (for example, oil change overdue, oil temperature too high, or others), and provides instructions, tips, or tutorials selected based on the metrics to facilitate assisting the user in providing appropriate maintenance or repairs to the vehicle. For example, one or more metrics may be compared to one or more thresholds and, if the one or more metrics meet, exceed, or fail to meet or exceed the one or more thresholds, the vehicle component may be determined to be within specification or outside of specification. Responsive to determining that a vehicle component is outside of specification (or, based on a predetermined number of recent metrics, is trending toward being outside of specification), the client device may provide an alert to the user and an instruction on how to address the issue. For example, the client device may load a video provided by a backend server.

In some embodiments, the mechanic-assistance module provides error codes (e.g., Diagnostic Trouble Codes (DTCs)) and/or vehicle issues 1106 determined from error codes. For example, the copilot device may obtain one or more error codes via the OBD connection and may associate a particular issue with the error code based on a mapping of error codes to various issues for a vehicle type.

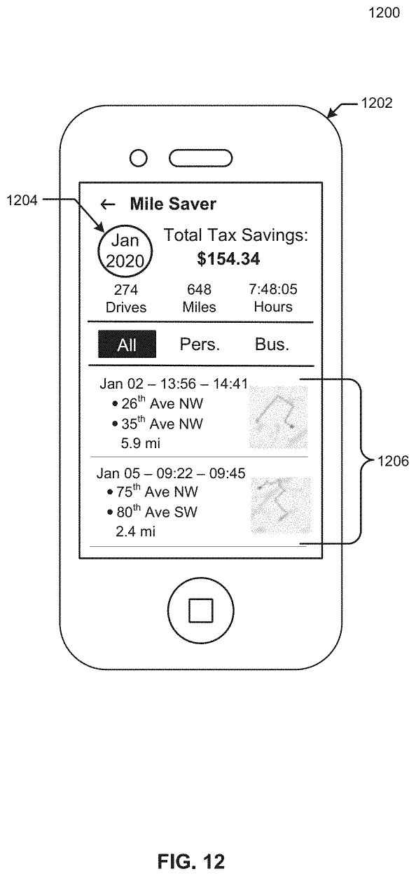

FIG. 12 depicts an example graphical user interface that may be instantiated on a client device to convey mileage information from a copilot device to a driver of the vehicle in accordance with at least some embodiments. In some embodiments, a mobile application installed on the client device 1202 may include a mile-saver module that presents the received mileage information.

In some embodiments, a copilot device obtains odometer data from the OBD connection in predetermined intervals (for example, every two seconds) and stores the obtained data in a database (for example, a SQLite database). Responsive to the client device executing the mile-saver module and providing a mileage request to the copilot device (for example, an HTTP request), the copilot device parses a mileage log (for example, date, time, location, start/stop odometer reading) into a mileage log data object (for example, a JSON file) and provides the data object to the client device. Each request may pertain to a specified period of time 1204. For example, the user may request a mileage log for a particular day, month, or year.

Responsive to obtaining the mileage log data object, the client device generates and provides metrics associated with the mileage log data. At least a portion of data in the mileage log data may be presented as individual mileage log events. In some embodiments, the client device facilitates the user indicating whether a current, past, or future driving session related to personal or business usage and, based on that selection, generates mileage logs that comply with Internal Revenue Services (IRS) requirements in order to facilitate the user conveniently obtaining a tax return or write-off based on the vehicle usage (for example, a generated PDF file that includes the log).

The client device 1202 may be further capable of providing the mileage log to another electronic device. For example, a user of the client device 1202 may forward the mileage log through a selected communication means (e.g., text message, email, etc.).

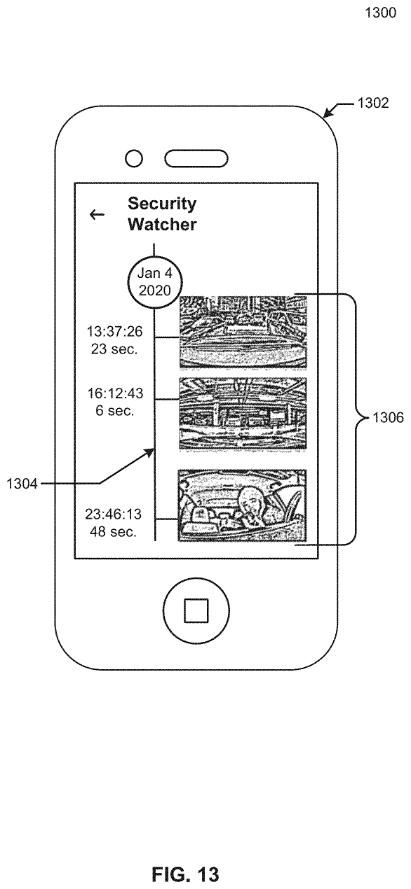

FIG. 13 depicts an example graphical user interface that may be instantiated on a client device to convey security event information from a copilot device to a driver of the vehicle in accordance with at least some embodiments. In some embodiments, a mobile application installed on the client device 1302 may include a security module that presents the received security event information.

As noted elsewhere, a copilot device may include a security module that generates certain data upon detecting a security event. A security event may include an opening of one or more doors of the vehicle (as detected via a door open indicator signal received via the OBD connection) when no key is present, a movement of the vehicle (as detected by an accelerometer or other suitable sensor) when the vehicle is unpowered (which may indicate a collision or impact), a received sound signal that shares a high degree of similarity with a sound of breaking of glass, activation of a motion detector, or any other suitable indication of a potential security breach of the vehicle. Upon detection of the event, the security module 216 may capture video or images from the cameras 208 to the copilot management computer 118. The video or images may be associated with a timestamp and may be modified to include other suitable data relevant to the potential security event. For example, upon detecting that a vehicle door has been opened while no key is present, the copilot device may begin to capture video and may continue to capture video for some predetermined period of time. In this example, an indication of the type of security event (e.g., “door open”) may be appended to the video as metadata along with a timestamp, location, and/or any other suitable data to generate a video file. The generated video file may be provided to a client device 1302. In some embodiments, the generated video file is provided to the client device 1302 directly via a wireless communication means. In some embodiments, the generated video file is provided to a backend server (e.g., copilot management computer 118) and then routed to the client device via a network connection.

The client device 130 may append information relevant to a security event (e.g., a thumbnail image generated from a video file) to a timeline 1304. The timeline 1304 may facilitate tracking of security events 1306 with respect to date/time. In some embodiments, selection of a particular security event of the security events 1306 presented on a timeline 1304 may cause the client device 1302 to present additional details related to the selected security event. For example, the user may be provided the ability to view the video, view a location of the security event on a map, or otherwise interact with information related to the security event.

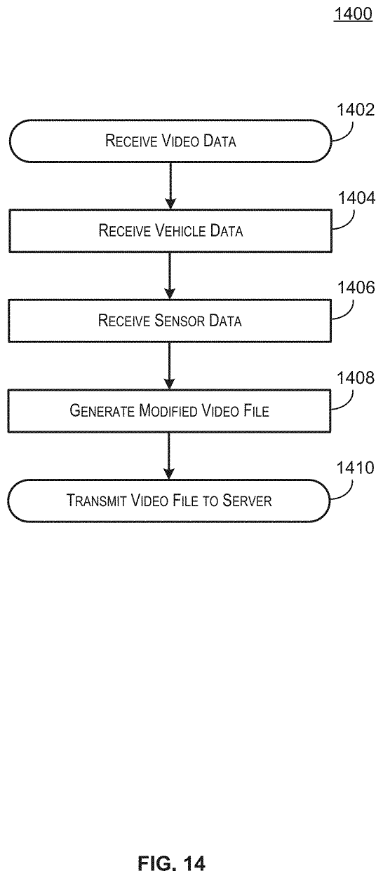

FIG. 14 depicts a flow diagram depicting an example process for generating and transmitting a modified video file to a server in accordance with at least some embodiments. The process 1400 may be performed by a copilot device (e.g., copilot device 106 as described with respect to FIG. 1).

At 1402, the process 1400 comprises receiving video data at a copilot device. The video data includes video of a vehicle interior and one or more passengers captured using an internal (e.g., rear-facing) camera. In some cases, the video of the vehicle interior may be captured in night vision mode (e.g., using a camera capable of capturing infrared light). The video data also includes video of a vehicle exterior in front of the vehicle captured using one or more external (e.g., front-facing) cameras. In some embodiments, the one or more external camera may include multiple stereo cameras capable of capturing a scene from various angles.

At 1404, the process 1400 comprises receiving vehicle data via a connection between a vehicle and the copilot device. In some cases, the connection between the vehicle and the copilot device is an on-board diagnostic (OBD) connection. As noted elsewhere, the copilot device may collect various types of vehicle data via the OBD connection. For example, vehicle data may include odometer information, speedometer information, fuel gauge information, or error code information.

At 1406, the process 1400 comprises receiving sensor data from one or more sensors in communication with the copilot device. As noted elsewhere, the copilot device may include a number of different sensor types that collect various types of sensor data. For example, sensor data may include temperature data, acceleration data, time data, location data, light level data, or moisture level data.

At 1408, the process 1400 comprises generating a modified video file that includes the video data, at least a portion of the vehicle data, and at least a portion of the sensor data. This may involve appending the portion of the vehicle data and the portion of the sensor data to the video data. More particularly, the portion of the vehicle data and the portion of the sensor data may be appended as metadata to a footer of the video data. Within the modified video file, the portion of the vehicle data, the portion of the sensor data, and the video data are synchronized based on a time at which the data was received in the modified video file.

At 1410, the process 1400 comprises transmitting the modified video file to a server. More particularly, the modified video file is transmitted to a copilot management computer remote to the copilot device.

In some embodiments, the process 1400 may further comprise receiving an indication of a start of a business event and an end of the business event and determining a mileage associated with the business event. In these embodiments, determining a mileage associated with the business event may involve determining a first mileage at the start of the business event, determining a second mileage at the end of the business event, and subtracting the first mileage from the second mileage. Each of the first mileage and the second mileage is determined from odometer information within the vehicle data at a time corresponding to each of the respective start and end of the business event.

Embodiments of the current disclosure provide for several advantages over conventional systems. For example, the disclosed copilot device generates a single data file in which multiple disparate types of data are combined in a manner such that the data is synchronized based on time. This enables a downstream system (e.g., the copilot management computer) to draw correlations between the disparate data without having to match up or align the disparate data, significantly increasing the efficiency of processing.

Additionally, embodiments of the disclosed system enable various functionality to be automated in a manner that would not otherwise be automatable via an aftermarket solution. For example, the system provides a means of automatically detecting and recording business events for tax purposes in a very accurate manner. This enables a user to obtain extremely accurate mileage records with minimal effort while eliminating or reducing errors in those mileage records. In some embodiments, the system enables automation of various vehicle functions in vehicles that would not typically be capable of automating those functions. For example, the system enables the automatic activation of windshield wipers or headlights based on video and/or sensor data collected by the copilot device.

### CONCLUSION

As used herein, the following terms take the meanings explicitly associated herein, unless the context clearly dictates otherwise. The term “or” is an inclusive grammatical conjunction to indicate that one or more of the connected terms may be employed. For example, the phrase “one or more A, B, or C” or the phrase “one or more As, Bs, or Cs” is employed to discretely disclose each of the following: i) one or more As, ii) one or more Bs, iii) one or more Cs, iv) one or more As and one or more Bs, v) one or more As and one or more Cs, vi) one or more Bs and one or more Cs, and vii) one or more As, one or more Bs, and one or more Cs. The term “based on” as used herein is not exclusive and allows for being based on additional factors not described. The articles “a,” “an,” and “the” include plural references. Plural references are intended to also disclose the singular.

The terms “front,” “forward,” “rear,” and “rearward” are defined relative to the longitudinal axis of the vehicle or the copilot device 106 when installed in the vehicle. The longitudinal axis of the vehicle extends from the rearmost portion of the vehicle to the frontmost end of the vehicle along the lateral middle of the vehicle. The terms “front” and “forward” indicate the end portion closer to or in the direction of the headlights of the vehicle when the copilot device 106 is installed (to the right in FIG. 1). The terms “rear” and “rearward” indicate the end portion closer to or in the direction of the tailgate of the truck when the storage panel system is installed (to the left in FIG. 6). The terms “height,” “vertical,” “upper,” “lower,” “above,” “below,” “top,” “bottom,” “topmost,” and “bottom-most” are defined relative to vertical axis of the vehicle or the copilot device 106 when installed in the vehicle. The vertical axis is transverse to the longitudinal axis and is defined as parallel to the direction of the earth's gravity force on the vehicle or the copilot device 106 when the vehicle is on horizontal ground. The term “lateral” is defined relative to the lateral axis of the vehicle or the copilot device 106 when installed in the vehicle. The lateral axis is transverse to the longitudinal and vertical axes.

The term “aftermarket” or “pre-existing vehicle” refers to vehicles that have been fully assembled and sold from a dealership in the ordinary course of business such that the manufacturer of the vehicle and the dealership no longer have control over the vehicle.

Notably, vehicles are of various shapes and sizes. Accordingly, some features or characteristics are best understood by one of ordinary skill in the art when defined relative to one or more elements that are related to, yet are not comprised in the embodiments, such as one or more features or characteristics of vehicles, dashboard, gas tanks, handlebars, windshields, windscreens, or others. Also accordingly, where features or characteristics of the embodiments are defined herein relative to one or more elements that are related to yet are not comprised in the embodiments, such definitions are as accurate as the subject matter permits. It should also be noted that one of ordinary skill in the art realizes from the present disclosure that those features or characteristics of the embodiments could be easily obtained according to the principles of the embodiments for a given vehicle component that is not comprised in the embodiments.

While many embodiments have been illustrated and described, as noted above, many changes can be made without departing from the spirit and scope of the features or characteristics described. For example, each disclosure of a component having a feature or characteristic is intended to also disclose the component as being devoid of that feature or characteristic, unless the principles of the embodiments clearly dictate otherwise. Accordingly, the scope of the embodiments are not limited by the specific features or characteristics described.

What is claimed is:

1. A method comprising:
receiving, by a copilot device, video data obtained by a camera included in the copilot device;
receiving, by the copilot device, vehicle data via a connection between a vehicle and the copilot device;
receiving, by the copilot device, sensor data from one or more sensors in communication with the copilot device;
generating, by the copilot device, a modified video file that includes the video data, at least a portion of the vehicle data, and at least a portion of the sensor data; and
transmitting, by the copilot device, the modified video file to a copilot management computer remote to the copilot device.

2. The method of claim 1, wherein the connection between the vehicle and the copilot device comprises an on-board diagnostic (OBD) connection.

3. The method of claim 1, further comprising:
receiving, by the copilot device, an indication of a start of a business event and an end of the business event; and
determining a mileage associated with the business event.

4. The method of claim 3, wherein determining a mileage associated with the business event comprises:
determining a first mileage at the start of the business event and a second mileage at the end of the business event; and
subtracting the first mileage from the second mileage.

5. The method of claim 4, wherein the first mileage is determined from odometer information received from the connection between the vehicle and the copilot device at a time of the start of the business event.

6. The method of claim 1, wherein generating the modified video file comprises appending the portion of the vehicle data and the portion of the sensor data to the video data.

7. The method of claim 6, wherein the portion of the vehicle data and the portion of the sensor data are appended to a footer of the video data.

8. The method of claim 6, wherein the portion of the vehicle data, the portion of the sensor data, and the video data are synchronized based on a time at which the data was received in the modified video file.

9. A copilot computing device comprising:
one or more cameras;
a connection between a vehicle and the copilot computing device;
one or more sensors;
a processor; and
a memory including instructions that, when executed with the processor, cause the copilot computing device to, at least:
receive video data obtained by the one or more cameras included in the copilot device;
receive vehicle data via the connection between a vehicle and the copilot computing device;
receive sensor data from the one or more sensors in communication with the copilot device;
generate a modified video file that includes the video data, at least a portion of the vehicle data, and at least a portion of the sensor data; and
transmit the modified video file to a copilot management computer remote to the copilot device.

10. The copilot computing device of claim 9, wherein the sensor data comprises temperature data, acceleration data, time data, location data, light level data, or orientation data.

11. The copilot computing device of claim 9, wherein the video data comprises internal video data and external video data.

12. The copilot computing device of claim 11, wherein the internal video data comprises video captured of one or more passengers within an interior of the vehicle.

13. The copilot computing device of claim 12, wherein the video captured of the one or more passengers comprises video captured using infrared light.

14. The copilot computing device of claim 11, wherein the external video data comprises multiple videos captured of an exterior of the vehicle from a plurality of stereo cameras.

15. The copilot computing device of claim 9, wherein the vehicle data comprises at least one of odometer information, speedometer information, fuel gauge information, error code information, or other information received from a Controller Area Network bus of the vehicle.

16. A system comprising:
a copilot device comprising a memory including instructions that cause the copilot device to:
obtain disparate vehicle-related data comprising at least video data, sensor data, and vehicle data received via a connection with a vehicle;
combine the disparate vehicle-related data into a single data file; and
provide the single data file to a copilot management computer; and
a copilot management computer communicatively coupled with the copilot device and configured to process the single data file received from the copilot device.

17. The system of claim 16, further comprising a client device having installed upon it a mobile application, the mobile application enabling interaction between the client device and the copilot device.

18. The system of claim 16, wherein the copilot management computer trains a machine learning algorithm using the received data file to generate a trained model, and the copilot management computer is further configured to provide the trained model to the copilot device.

19. The system of claim 18, wherein the trained model causes the copilot device to automate one or more vehicle functions upon detecting a set of conditions.

20. The system of claim 19, wherein the set of conditions is detected within video data or sensor data collected by the copilot device.
